(19) United States
(12) Patent Application Publication
(10) Pub. No.: US 2025/0097348 A1
(43) Pub. Date: Mar. 20, 2025

(54) SYSTEM AND METHOD FOR SUPPORTING CONTACT CENTER

(71) Applicant: Hitachi, Ltd., Tokyo (JP)

(72) Inventor: Takashi SUMIYOSHI, Tokyo (JP)

(21) Appl. No.: 18/783,535

(22) Filed: Jul. 25, 2024

(30) Foreign Application Priority Data
Sep. 14, 2023 (JP) 2023-149023

(51) Int. Cl. H04M 3/51; G10L 13/033; G10L 15/08; G10L 15/22; G10L 25/63; G10L 25/90

(52) U.S. Cl. CPC H04M 3/5183; G10L 13/0335; G10L 15/08; G10L 15/22; G10L 25/63; G10L 25/90; G10L 2015/088; H04M 2201/39; H04M 2201/405

(57) ABSTRACT

A contact center support system is a system that supports a contact center and includes a control unit that executes a plurality of processes for communication performed between an operator of the contact center and a customer, in which the communication includes a call between the operator and the customer, the plurality of processes include at least a voice recognition process of recognizing at least a content of the customer's utterance from a voice of the call, an emotion recognition process of recognizing at least the customer's emotion from the voice of the call, and a filtering process of filtering the content of the utterance of the customer and/or the operator in the call, and the control unit simultaneously executes the processes included in the plurality of processes in parallel.

### CROSS-REFERENCE TO RELATED APPLICATION

The present application claims priority from Japanese application JP2023-149023, filed on Sep. 14, 2023, the content of which is hereby incorporated by reference into this application.

### BACKGROUND OF THE INVENTION

### 1. Field of the Invention

The present invention relates to technology for supporting a contact center.

### 2. Description of Related Art

Today, many companies have opened various contact centers (hereinafter simply referred to as “contact centers”), including call centers, to improve services provided to their customers and to increase customer satisfaction.

The main role of these contact centers is generally to respond appropriately to various requests from customers, such as receiving consultations, questions, requests, opinions, complaints, and the like from customers by means of telephone, e-mails, and the like, causing operators to respond to the consultations, questions, and the like from the customers, and providing support for products and services.

Various techniques for appropriately operating such contact centers have been proposed (see, for example, JP2007-041443A and JP2015-141428A).

Many operators who are engaged in customer service work at contact centers are exposed to a lot of stress every day due to reasons such as being yelled at or hearing harsh words by customers they responded to. For this reason, regarding the operation of contact centers, there has been a long-standing problem that a turnover rate of operators is much higher than in other occupations due to such harsh working conditions, making it difficult for operators to work stably for a long period.

In addition, regarding the operation of contact centers, there are various other problems such as reducing a workload on operators and reducing the risk of information leakage when an operator is engaged in customer service work in a remote environment such as home or a co-working space.

One of the means to solve these problems surrounding the operation of contact centers is to perform filtering on various communications, such as phone calls between operators and customers. However, it is difficult to apply various filtering processes to communications between operators and customers in real time without delaying the communications in contact centers using existing technology, and the development of new technology has been awaited.

### SUMMARY OF THE INVENTION

The invention has been made in view of the above-described problems, and an object thereof is to provide technology for making it possible to minimize delays in communications such as phone calls between operators and customers at contact centers and perform filtering on the communications in real time.

A contact center support system according to the invention is a system that supports a contact center and includes a control unit that executes a plurality of processes for communication performed between an operator of the contact center and a customer, in which the communication includes a call between the operator and the customer, the plurality of processes include at least a voice recognition process of recognizing at least a content of the customer's utterance from a voice of the call, an emotion recognition process of recognizing at least the customer's emotion from the voice of the call, and a filtering process of filtering the content of the utterance of the customer and/or the operator in the call, and the control unit simultaneously executes the processes included in the plurality of processes in parallel.

Other problems and solutions disclosed in the present application will be made apparent in the section of the preferred embodiment of the invention and the drawings.

According to the invention, it is possible to minimize delays in communications such as phone calls between operators and customers at contact centers and perform filtering on the communications in real time.

### BRIEF DESCRIPTION OF THE DRAWINGS

FIG. 1 is a diagram showing an example of the overall configuration of a system including a contact center support system according to an embodiment;

FIG. 2 is a diagram showing an example of a configuration of a filter dictionary/rule storage database;

FIG. 3 is a diagram showing an example of a configuration of a response candidate generation data storage database;

FIG. 4 is a flowchart showing an example of operations of a customer/operator voice detection unit;

FIG. 5 is a flowchart showing an example of operations of a voice recognition unit;

FIG. 6 is a flowchart showing an example of operations of an emotion recognition unit;

FIG. 7 is a flowchart showing an example of operations of a customer voice conversion unit;

FIG. 8 is a flowchart showing an example of operations of an operator voice conversion unit;

FIG. 9 is a flowchart showing an example of operations of a voice synthesis unit;

FIG. 10 is a flowchart showing an example of operations of a filtering unit;

FIG. 11 is a flowchart showing an example of operations of a voice filtering unit;

FIG. 12 is a flowchart showing an example of operations of a response candidate generation unit;

FIG. 13 is a flowchart showing an example of operations of an operator screen control unit;

FIG. 14 is a flowchart showing an example of operations of a customer/operator voice transmission unit; and

FIG. 15 is a flowchart showing an example of a flow of the overall processing executed by a control unit.

### DESCRIPTION OF EMBODIMENTS

In the following description, an “interface apparatus” may be one or more interface devices. The one or more interface devices may be at least one of the following devices.
One or more input/output (I/O) interface devices. The input/output (I/O) interface device is an interface device for at least one out of an I/O device and a remote display computer. The I/O interface device for the display computer may be a communication interface device. The at least one I/O device may be a user interface device, for example, either an input interface device such as a keyboard and a pointing device, or an output interface device such as a display device.
One or more communication interface devices. The one or more communication interface devices may be one or more same type of communication interface devices (for example, one or more network interface cards (NICs)) or two or more different types of communication interface devices (for example, a NIC and a host bus adapter (HBA)).

Further, in the following description, a “memory” may be one or more memory devices, which is an example of one or more storage devices, and may typically be a main storage device. At least one memory device in the memory may be a volatile memory device or a non-volatile memory device.

Further, in the following description, a “persistent storage apparatus” may be one or more persistent storage devices, which is an example of one or more storage devices. The persistent storage device may typically be a non-volatile storage device (for example, an auxiliary storage device), and specifically, may be, for example, a hard disk drive (HDD), a solid state drive (SSD), a non-volatile memory express (NVME) drive, or a storage class memory (SCM).

Further, in the following description, a “storage apparatus” may be at least a memory out of the memory and a persistent storage apparatus.

Further, in the following description, a “processor” may be one or more processor devices. The at least one processor device may typically be a microprocessor device such as a central processing unit (CPU), but may also be other types of processor devices such as a graphics processing unit (GPU). The at least one processor device may be a single-core or a multi-core. The at least one processor device may be a processor core. The at least one processor device may also be a processor device in a broad sense such as a circuit that is an assembly of gate arrays (for example, a field-programmable gate array (FPGA), a complex programmable logic device (CPLD) or an application specific integrated circuit (ASIC)), written in a hardware description language, which perform some or all of processes.

Further, in the following description, functions may be described using the expression “xxx unit”, but the functions may be realized by one or more computer programs being executed by a processor, may be realized by one or more hardware circuits (for example, an FPGA or an ASIC), or may be realized by a combination thereof. When a function is realized by a program being executed by a processor, a determined process is performed using a storage apparatus and/or an interface apparatus, or the like, as appropriate, and thus the function may be at least a part of the processor. Processing described with a function as the subject may be a process performed by a processor or an apparatus including the processor. A program may be installed from a program source. The program source may be, for example, a program distribution computer or a computer-readable recording medium (for example, a non-transitory recording medium). The description of each function is an example, and a plurality of functions may be combined into one function, or one function may be divided into a plurality of functions.

Further, in the following description, information that produces an output for an input may be described using expressions such as “yyy table”, but the information may be a table having any structure, or may be a neural network that produces an output for an input, or a learning model represented by a genetic algorithm or a random forest. Thus, “yyy table” may be referred to as “yyy information”. Further, in the following description, the configuration of each table is an example, and one table may be divided into two or more tables, or all or some of two or more tables may be one table.

Further, in the following description, a process may be described using a “program” as the subject, but the process described using a program as the subject may also be a process performed by a processor or an apparatus that includes the processor. In addition, two or more programs may be realized as one program, and one program may be realized as two or more programs.

Furthermore, in the following description, a “contact center support system” may be a system (for example, a cloud computing system) realized on a physical computing resource group (for example, a cloud infrastructure), or a system (for example, an on-premises system) constituted by one or more physical computers. When a contact center support system “displays” display information, it may mean that the display information is displayed on a display device included in the computer, or it may mean that the computer transmits the display information to a display computer (in the latter case, the display information is displayed by the display computer).

The present embodiment will be described in detail below with reference to the drawings.

In the following description, the same or similar components may be given the same reference numerals to omit repeated description.

In addition, when there are a plurality of elements having the same or similar functions, different suffixes may be added to the same reference numerals to distinguish between the plurality of elements. On the other hand, when it is not necessary to distinguish between the plurality of elements, the suffixes may be omitted.

### <Configuration Example of Contact Center Support System 100>

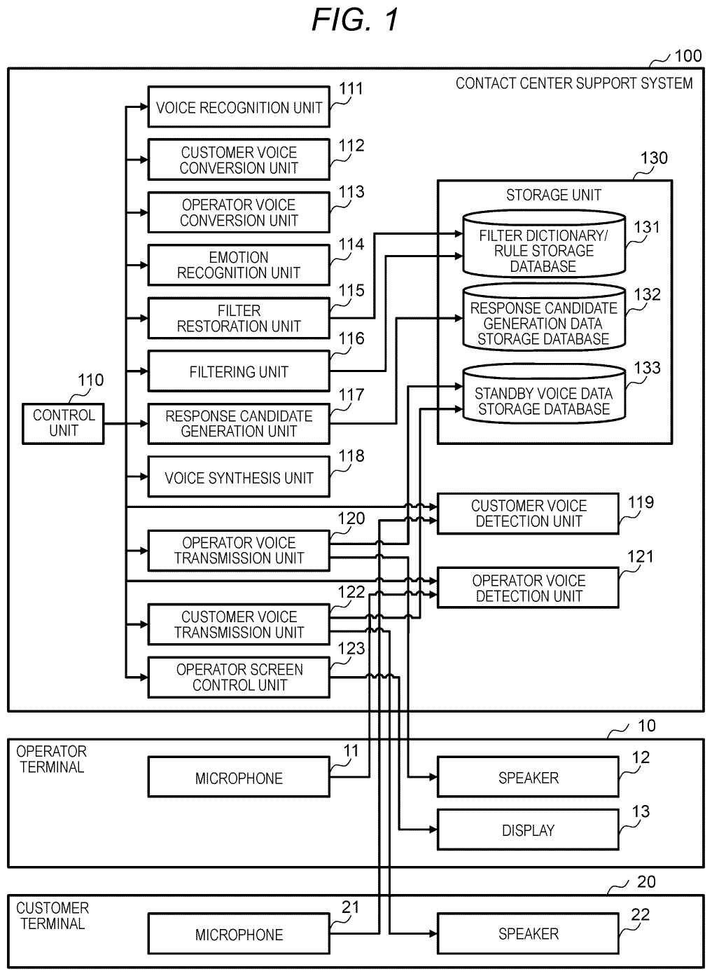

First, a configuration example of a contact center support system 100 according to this embodiment will be described with reference to FIG. 1. FIG. 1 is a schematic diagram showing an example of the overall configuration of a system including the contact center support system 100.

### (Configuration Example of Overall System)

The contact center support system 100 of this embodiment is a computer system capable of supporting various contact centers including call centers, and is realized by a computer apparatus or a server apparatus having components to be described below.

As shown in FIG. 1, the contact center support system 100 is connected to terminals 10a, 10b, 10c, . . . , and 10n (hereinafter collectively referred to as “operator terminals 10” when collectively referred to or when no particular distinction is made) which are used by operators of a contact center (hereinafter also referred to as “the contact center”) that is to be supported by the contact center support system 100 so as to perform data communication with each other via an appropriate communication network (hereinafter simply referred to as a “network”) such as the Internet or a dedicated line. The operator terminal 10 includes at least a microphone 11 as an input apparatus. The operator terminal 10 also includes at least a speaker 12 and a display 13 as output apparatuses. Thereby, the contact center support system 100 and the operator terminal 10 can communicate with each other via a voice using, for example, a Voice over Internet Protocol (VOIP).

Similarly, as shown in FIG. 1, the contact center support system 100 is connected to terminals 20a, 20b, 20c, . . . , and 20n (hereinafter collectively referred to as “customer terminals 20” when collectively referred to or when no particular distinction is made), such as smartphones, tablet PCS, or laptop PCs, which are owned by customers who make various inquiries to the contact center so as to perform data communication with each other via an appropriate network such as the Internet or a dedicated line. The customer terminal 20 includes at least a microphone 21 as an input apparatus. The customer terminal 20 also includes at least a speaker 22 as an output apparatus. Thereby, the contact center support system 100 and the customer terminal 20 can perform voice communications with each other using, for example, a Voice over Internet Protocol (VOIP).

The contact center support system 100 and the operator terminal 10 are connected to the network via known communication equipment (not shown) in a wired manner, but may be connected to each other in a wireless manner. In addition, the customer terminal 20 is connected to the network in a wireless manner, but may be connected to each other in a wired manner.

In this embodiment, description has been given on the assumption that the contact center support system 100 is constituted by one apparatus, as shown in FIG. 1. However, for example, the contact center support system 100 may be constituted by a plurality of apparatuses.

Further, in this embodiment, description has been given on the assumption that the contact center support system 100 and the operator terminal 10 are constituted by separate apparatuses, as shown in FIG. 1. However, the contact center support system 100 and the operator terminal 10 may be constituted by the same apparatus. In this case, the contact center support system may be configured as, for example, a system including the operator terminal 10. In addition, for example, the contact center support system may be configured to have some or all of the functions performed by the operator terminal 10.

Furthermore, other computer apparatuses, server apparatuses, and the like (hereinafter also referred to as “other apparatuses”) may be connected to the contact center support system 100 so as to perform data communication with each other via a network. In this case, the other apparatuses and the network may be connected to each other in a wired manner via well-known communication equipment (not shown) or may be connected to each other in a wireless manner.

### (Example of Hardware Configuration of Contact Center Support System 100)

Next, an example of a hardware configuration of the contact center support system 100 according to this embodiment will be described.

The contact center support system 100 of this embodiment is realized by a single general-purpose computer apparatus. The following description will be given on the assumption that the contact center support system 100 is realized by a single general-purpose computer apparatus including one or more processors, one or more storage apparatuses, one or more interface apparatuses, and wired or wireless communication lines (none of which are shown) connecting them.

That is, the contact center support system 100 includes a storage apparatus including a persistent storage apparatus and a memory, an interface apparatus, and a processor connected to them.

The persistent storage apparatus is an auxiliary storage device constituted by a non-volatile storage element such as a flash memory. Specific examples of the persistent storage apparatus include a solid state drive (SSD) and a hard disk drive (HDD). The persistent storage apparatus stores at least a contact center support program. The contact center support program is a computer program for implementing functions required for the contact center support system 100.

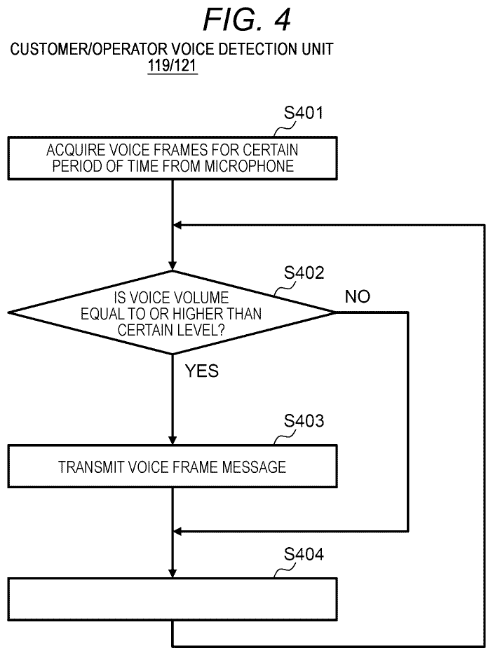

That is, the contact center support program is executed by the processor, and thus various processes described below with reference to FIGS. 4 to 15 are performed.

The contact center support program may be installed from a program source. The program source may be, for example, a program distribution computer or a computer-readable recording medium. In addition, the contact center support program may also be constituted by a device driver, an operating system, various application programs located in higher layers thereof, and a library that provides common functions to these programs. Furthermore, two or more programs may be realized as one contact center support program, and one contact center support program may be realized as two or more programs.

The memory is a main storage device mainly constituted by a volatile storage element such as a random access memory (RAM). The memory temporarily stores data representing various pieces of information read from the persistent storage apparatus and various pieces of data acquired from the operator terminal 10 and/or the customer terminal 20.

The processor is a processor device such as a central processing unit (CPU) and various co-processors. This processor calls up the contact center support program into the memory and executes it, thereby comprehensively controlling the contact center support system 100 itself and also serving as a control unit 110 that performs various processes such as a calculation process and a determination process.

The interface apparatus includes a communication interface device that is connected to a network and communicates with other apparatuses and terminals, and an I/O interface device.

### (Example of Functional Blocks of Contact Center Support System 100)

Next, an example of blocks having various functions and included in the contact center support system 100 according to this embodiment will be described with reference to FIG. 1. The blocks to be described below represent function-based blocks instead of representing a hardware-based configuration.

The contact center support system 100 is configured to include functional blocks, that is, the control unit 110, a storage unit 130, a communication unit (not shown), and a user interface unit (not shown) constituted by an input unit and an output unit.

The control unit 110 performs various data processes based on the programs and data stored in the storage unit 130 and the data acquired by the communication unit. The control unit 110 also functions as an interface between the storage unit 130 and the communication unit.

As shown in FIG. 1, the control unit 110 includes functional blocks, that is, a voice recognition unit 111, a customer voice conversion unit 112, an operator voice conversion unit 113, an emotion recognition unit 114, a filter restoration unit 115, a filtering unit 116, a voice filtering unit (not shown), a response candidate generation unit 117, a voice synthesis unit 118, a customer voice detection unit 119, an operator voice transmission unit 120, an operator voice detection unit 121, a customer voice transmission unit 122, and an operator screen control unit 123.

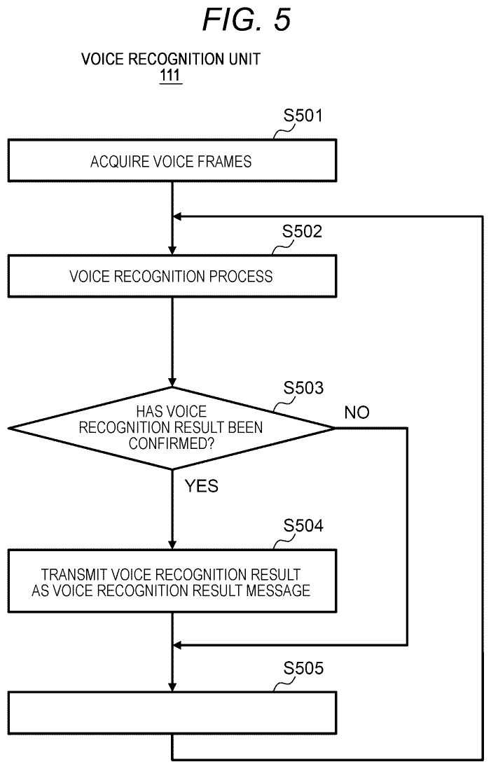

The voice recognition unit 111 executes a process of recognizing a voice of a customer and/or an operator (hereinafter also referred to as a “voice recognition process”) (to be described later in detail with reference to FIG. 5).

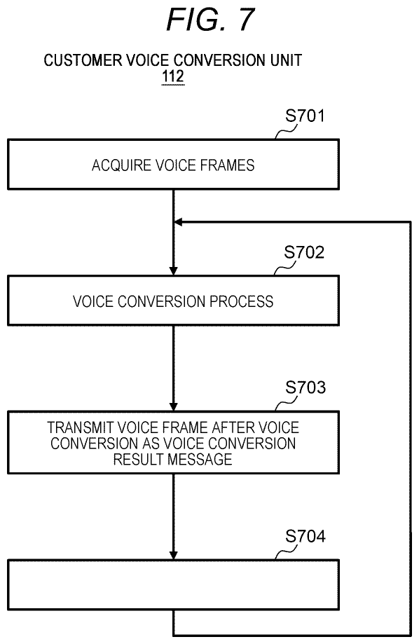

The customer voice conversion unit 112 executes a process of converting a customer's voice (to be described later in detail with reference to FIG. 7).

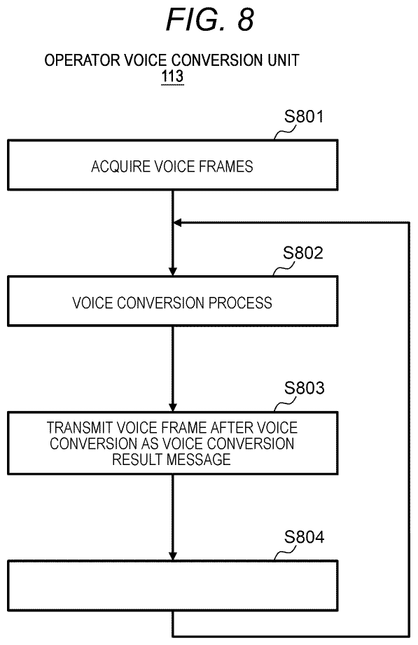

The operator voice conversion unit 113 executes a process of converting an operator's voice (to be described later in detail with reference to FIG. 8).

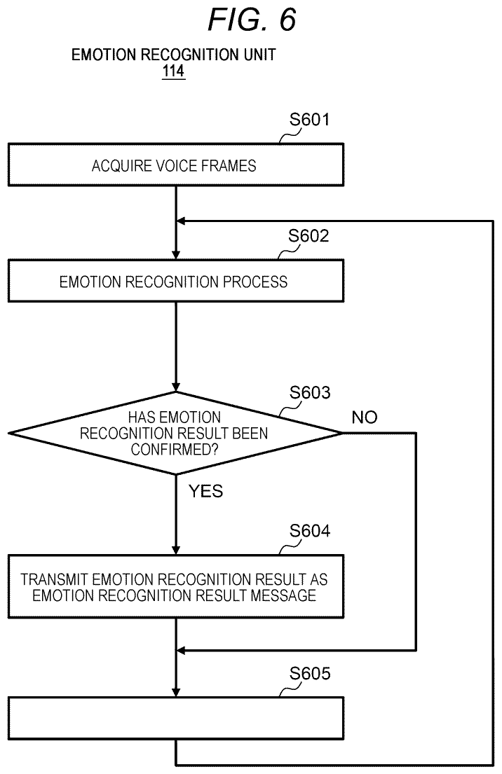

The emotion recognition unit 114 executes a process of recognizing a customer's emotion (hereinafter also referred to as an “emotion recognition process”) (to be described later in detail with reference to FIG. 6).

The filter restoration unit 115 executes a process of restoring a filter.

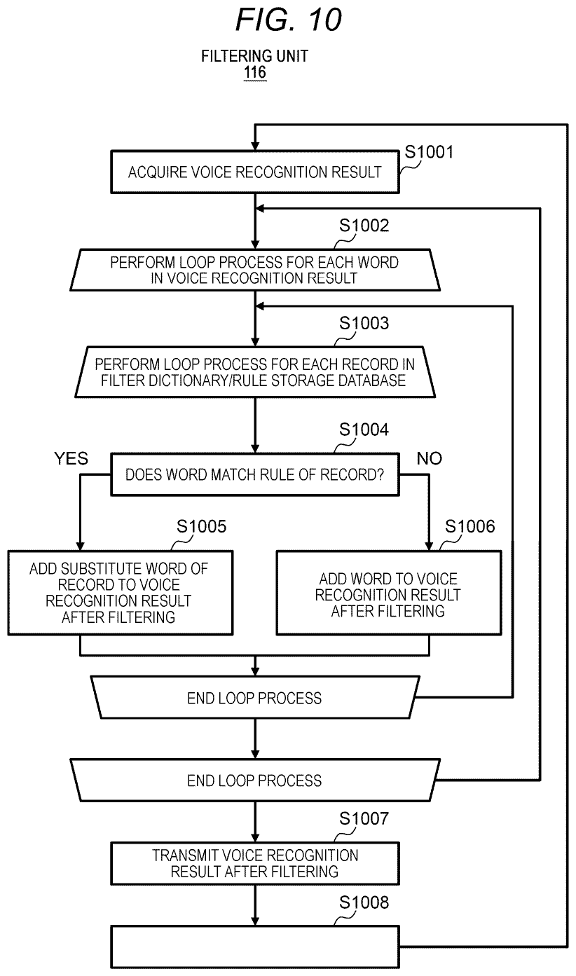

The filtering unit 116 executes a filtering process (to be described later in detail with reference to FIG. 10).

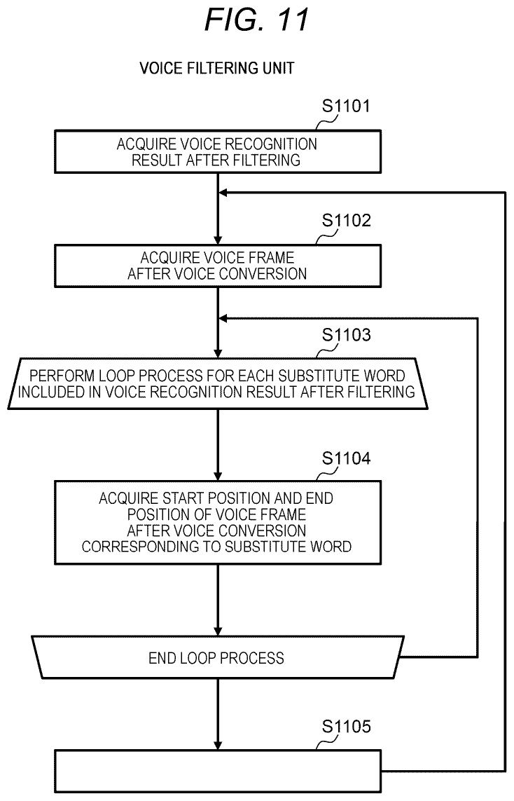

The voice filtering unit executes a voice filtering process (to be described later in detail with reference to FIG. 11).

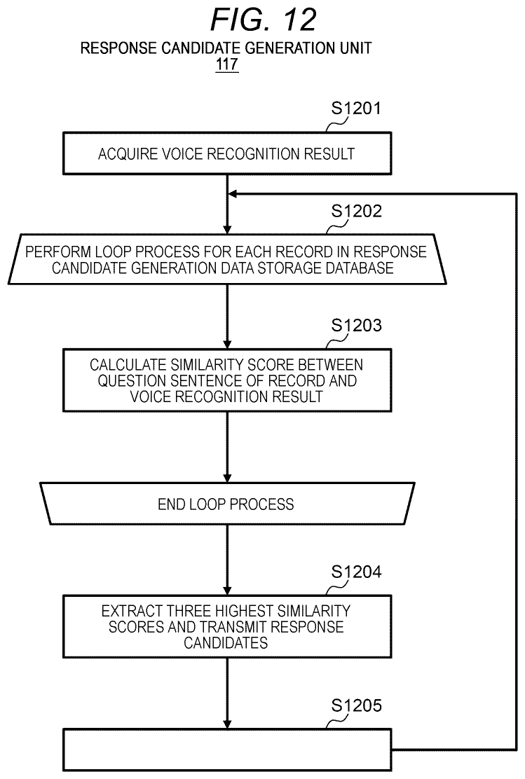

The response candidate generation unit 117 executes a process of generating response candidates for a customer (to be described later in detail with reference to FIG. 12).

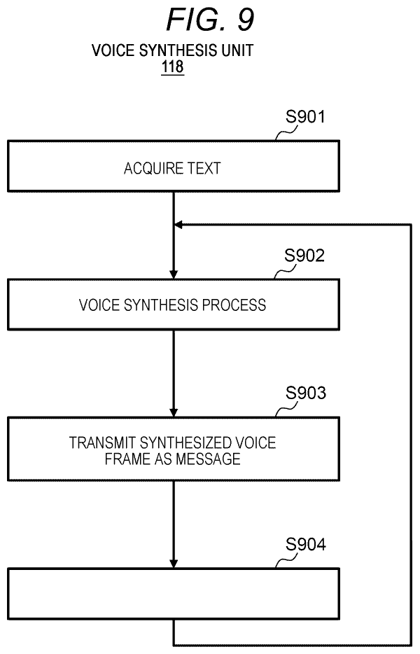

The voice synthesis unit 118 executes a process of synthesizing voices (to be described later in detail with reference to FIG. 9).

The customer voice detection unit 119 executes a process of detecting a customer's voice (to be described later in detail with reference to FIG. 4).

The operator voice transmission unit 120 executes a process of transmitting an operator's voice.

The operator voice detection unit 121 executes a process of detecting an operator's voice (to be described later in detail with reference to FIG. 4).

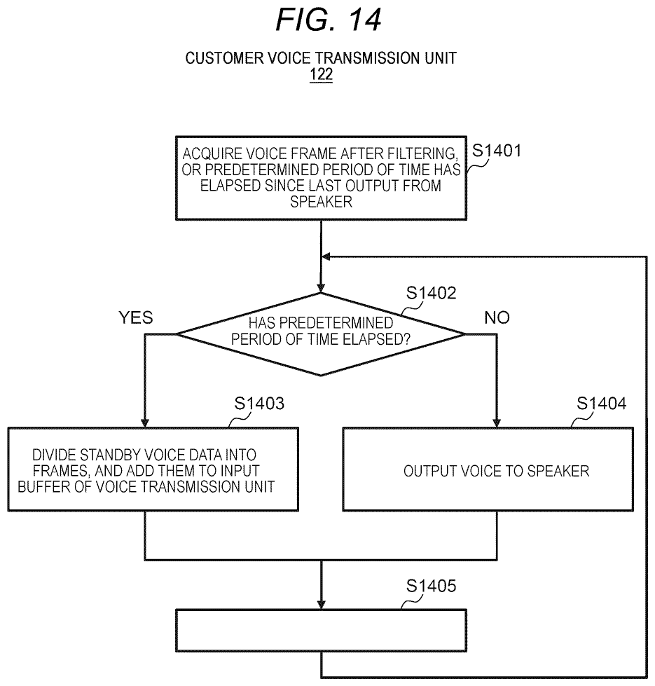

The customer voice transmission unit 122 executes a process of transmitting a customer's voice (to be described later in detail with reference to FIG. 14).

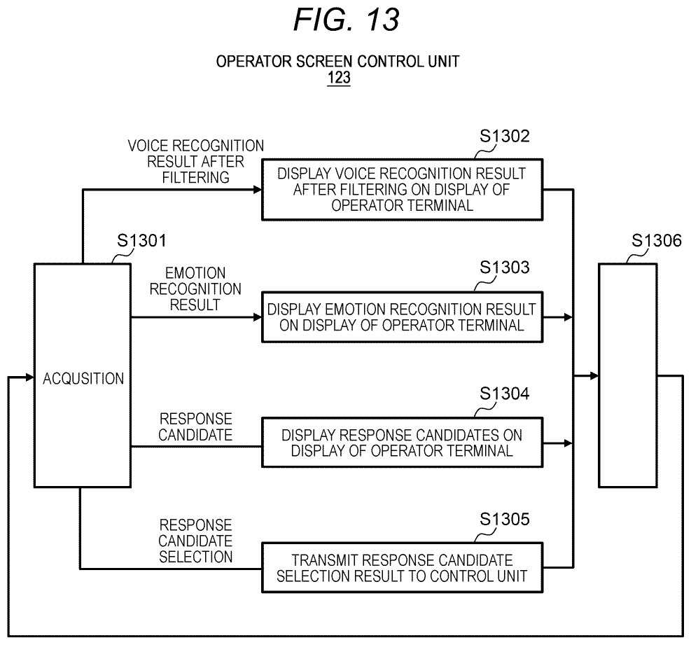

The operator screen control unit 123 executes a process of controlling the display 13 of the operator terminal 10 (to be described later in detail with reference to FIG. 13).

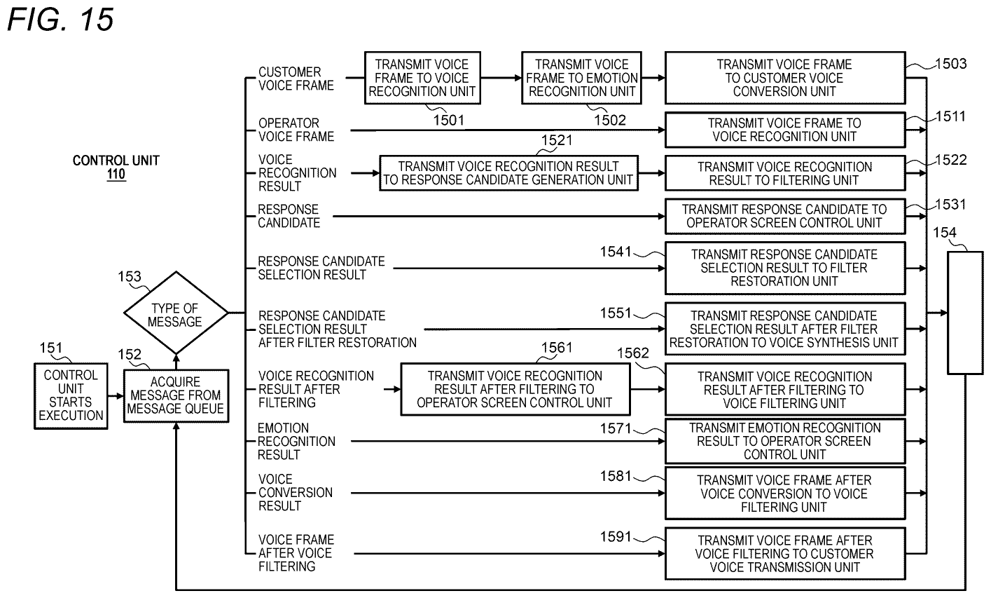

The control unit 110 operates these functional blocks in parallel, independently of each other (to be described later in detail with reference to FIG. 15). The control unit 110 may execute the processes executed in these functional blocks as a synchronous process in which the respective processes are synchronized with each other, or may execute the processes as an asynchronous process in which the respective processes are not synchronized with each other.

The control unit 110 is configured using a processor, and can realize these functional blocks by executing a predetermined contact center support program. The control unit 110 may be configured using a logic circuit such as a field programmable gate array (FPGA) instead of the processor. The control unit 110 may also be configured by combining the processor and the logic circuit.

The storage unit 130 is configured using, for example, a storage apparatus including a persistent storage apparatus and a memory, and stores programs for supplying various processing commands to the control unit 110 and data representing various pieces of information used in the process executed by the control unit 110.

The storage unit 130 includes functional blocks, that is, a filter dictionary/rule storage database 131, a response candidate generation data storage database 132, and a standby voice data storage database 133.

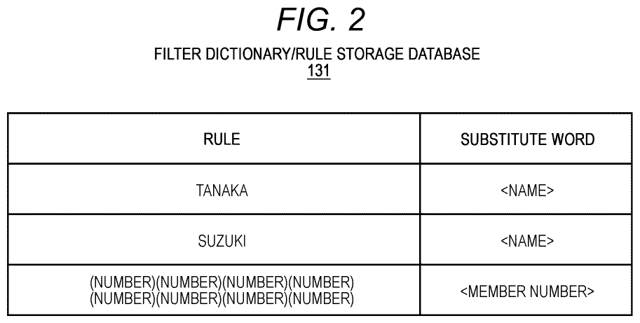

The filter dictionary/rule storage database 131 is a database that stores filter dictionaries/rules. An example of the configuration of the filter dictionary/rule storage database 131 is shown in FIG. 2. As shown in FIG. 2, the filter dictionary/rule storage database 131 has a record for each rule. The record represents, for example, an individual specific word that is the target of the rule, and another general and abstract word that substitutes for the word (hereinafter also referred to as a “substitute word”). That is, the filter dictionary/rule storage database 131 is a database for managing a dictionary and a rule of a filter for each rule by recording the word that is the target of the rule and the substitute word for the word in association with each other for each record. According to the example shown in FIG. 2, in the filter dictionary/rule storage database 131, it is recorded that a family name, a surname, and a last name included in a person's name such as “Tanaka” or “Suzuki” are substituted by a substitute word “<Name>”.

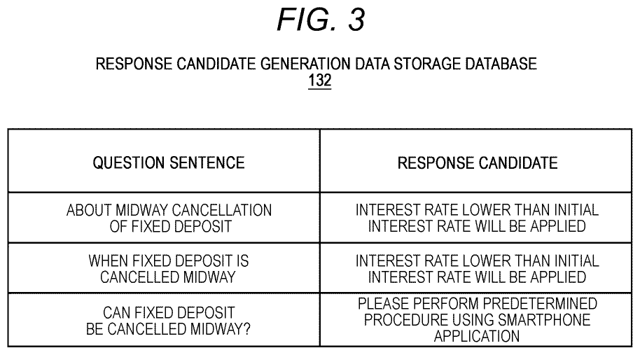

The response candidate generation data storage database 132 is a database that stores response candidate generation data. An example of the configuration of the response candidate generation data storage database 132 is shown in FIG. 3. As shown in FIG. 3, the response candidate generation data storage database 132 has a record for each question sentence. The record represents, for example, a question sentence corresponding to the content of a customer's inquiry and the content of a response corresponding to the question sentence, that is, a response candidate for the customer. That is, the response candidate generation data storage database 132 is a database for managing response candidates for the customer for each question sentence by recording a question sentence and a response candidate for the question sentence in association with each other for each record. According to the example shown in FIG. 3, in the response candidate generation data storage database 132, it is recorded that, when the content of a customer's inquiry corresponds to a question sentence such as “About canceling a fixed deposit midway” or “Case where a fixed deposit is cancelled midway”, a response candidate for the customer is “An interest rate lower than an initial interest rate will be applied”.

The control unit 110 of the contact center support system 100 may generate the response candidates stored in the response candidate generation data storage database 132 by using a neural network (NN), deep learning (DL), or the like.

The standby voice data storage database 133 is a database that stores standby voice data.

The control unit 110 can execute various processes by reading and writing this information from and to the storage unit 130.

The communication unit is responsible for a communication process with other equipment such as the operator terminal 10 and the customer terminal 20 via the Internet (an example of a network). The communication unit is configured using, for example, a network interface card (NIC) or a host bus adapter (HBA).

The user interface unit (not shown) is configured to include functional blocks of the input unit and the output unit.

The input unit is responsible for a process related to inputs, such as reception of input operations from a user, among processes related to a user interface. The input unit is configured using, for example, a keyboard, a pointing device, or a touch panel, and detects various operations from the user.

The output unit is responsible for a process related to outputs, such as display of various screens on a display device and the output of voice, among processes related to the user interface. The output unit is configured using, for example, a liquid crystal display or a touch screen.

That is, the components of the contact center support system 100 are realized by hardware including a processor, a storage apparatus such as a memory or a persistent storage apparatus, and wired or wireless communication lines and an interface apparatus for connecting them, and software stored in the storage apparatus and supplying processing commands to a computing unit.

In this embodiment, description has been made on the assumption that the functions of the contact center support system 100 are realized integrally by one computer apparatus. However, these functions may be realized by a plurality of computer apparatuses or server apparatuses connected to each other. Furthermore, the contact center support system 100 may be configured to include a general-purpose computer apparatus such as a laptop PC and a web browser installed thereon, or may be configured to include a web server and various portable devices.

Furthermore, the description of the above-described functions is merely an example, and a plurality of functions may be combined into one function, or one function may be divided into a plurality of functions.

Furthermore, the contact center support system 100 may have further functions in addition to the various functions described above. For example, the contact center support system 100 may be configured to include some of the various functions of the operator terminal 10.

### <Example of Operation of Contact Center Support System 100>

Next, an example of operations of each functional unit of the contact center support system 100 according to this embodiment will be described using FIGS. 4 to 15.

### (Example of Operations of Customer Voice Detection Unit 119/Operator Voice Detection Unit 121)

FIG. 4 is a flowchart showing an example of operations of the customer voice detection unit 119 and the operator voice detection unit 121. The operations shown in FIG. 4 are performed in common by the customer voice detection unit 119 and the operator voice detection unit 121.

In step S401, the control unit 110 of the contact center support system 100 executes a process of acquiring voice frames for a certain period of time from the microphones (11, 21) by the customer voice detection unit 119 and/or the operator voice detection unit 121. Thereby, the voice frames for a certain period of time are acquired from the microphones (11, 21). When the process in step S401 is ended, the control unit 110 of the contact center support system 100 proceeds to step S402.

In step S402, the control unit 110 of the contact center support system 100 executes a process of determining whether the voice volume is equal to or higher than a certain level for the voice frames acquired in step S401 by the customer voice detection unit 119 and/or the operator voice detection unit 121. When it is determined in step S402 that the voice volume of the voice frame is equal to or higher than the certain level (step S402: YES), the process proceeds to step S403 in order to transmit a voice frame message. On the other hand, when it is determined in step S402 that the voice volume of the voice frame is not equal to or higher than the certain level (step S402: NO), the process proceeds to step S404.

In step S403, the control unit 110 of the contact center support system 100 executes a process of transmitting a voice frame message for the voice frame for which it is determined in step S402 that the voice volume is equal to or higher than the certain level (step S402: YES) by the customer voice detection unit 119 and/or the operator voice detection unit 121. Thereby, a voice frame message is transmitted for the voice frame. When the process in step S403 is ended, the control unit 110 of the contact center support system 100 proceeds to step S404.

When the process in step S403 is ended, the control unit 110 of the contact center support system 100 returns to step S402 again in step S404. Also, when it is determined in step S402 that the voice volume of the voice frame is not equal to or higher than the certain level (step S402: NO), the control unit 110 of the contact center support system 100 returns to step S402 again.

### (Example of Operations of Voice Recognition Unit 111)

FIG. 5 is a flowchart showing an example of operations of the voice recognition unit 111.

In step S501, the control unit 110 of the contact center support system 100 executes a process of acquiring voice frames for a certain period of time by the voice recognition unit 111. Thereby, the voice frames for a certain period of time are acquired. When the process in step S501 is ended, the control unit 110 of the contact center support system 100 proceeds to step S502.

In step S502, the control unit 110 of the contact center support system 100 executes a voice recognition process on the voice frame acquired in step S501 by the voice recognition unit 111. The voice recognition process is a process of converting voice into text, and is executed by various techniques of the related art. Thereby, the voice recognition process is performed on the voice frame. When the process in step S502 is ended, the control unit 110 of the contact center support system 100 proceeds to step S503.

In step S503, the control unit 110 of the contact center support system 100 executes a process of determining whether the result of the voice recognition process (hereinafter also referred to as a “voice recognition result”) has been confirmed for the voice frame having been subjected to the voice recognition process in step S502 by the voice recognition unit 111. When it is determined in step S503 that the voice recognition result for the voice frame has been confirmed (step S503: YES), the process proceeds to step S504 in order to transmit the voice recognition result as a voice recognition result message. On the other hand, when it is determined in step S503 that the voice recognition result for the voice frame has not been confirmed (step S503: NO), the process proceeds to step S505.

In step S504, the control unit 110 of the contact center support system 100 executes a process of transmitting the voice recognition result as a voice recognition result message for the voice frame for which the voice recognition unit 111 has determined in step S503 that the voice recognition result has been confirmed (step S503: YES). Thereby, the voice recognition result for the voice frame is transmitted as a voice recognition result message. When the process in step S504 is ended, the control unit 110 of the contact center support system 100 proceeds to step S505.

When the process in step S504 is ended, the control unit 110 of the contact center support system 100 returns to step S502 again in step S505. In addition, when it is determined in step S503 that the voice recognition result for the voice frame has not been confirmed (step S503: NO), the control unit 110 of the contact center support system 100 returns to step S502 again.

### (Example of Operations of Emotion Recognition Unit 114)

FIG. 6 is a flowchart showing an example of operations of the emotion recognition unit 114.

In step S601, the control unit 110 of the contact center support system 100 executes a process of acquiring voice frames for a certain period of time by emotion recognition unit 114. Thereby, the voice frames for a certain period of time are acquired. When the process in step S601 is ended, the control unit 110 of the contact center support system 100 proceeds to step S602.

In step S602, the control unit 110 of the contact center support system 100 executes an emotion recognition process on the voice frame acquired in step S601 by the emotion recognition unit 114. The emotion recognition process is a process of outputting emotion categories such as anger or joy as text, and is executed by various techniques of the related art. Thereby, the emotion recognition process is performed on the voice frame. When the process in step S602 is ended, the control unit 110 of the contact center support system 100 proceeds to step S603.

In step S603, the control unit 110 of the contact center support system 100 executes a process of determining whether the result of the emotion recognition process (hereinafter also referred to as an “emotion recognition result”) for the voice frame having been subjected to the emotion recognition process in step S602 by the emotion recognition unit 114 has been confirmed. When it is determined in step S603 that the emotion recognition result for the voice frame has been confirmed (step S603: YES), the process proceeds to step S604 in order to transmit the emotion recognition result as an emotion recognition result message. On the other hand, when it is determined in step S603 that the emotion recognition result for the voice frame has not been confirmed (step S603: NO), the process proceeds to step S605.

In step S604, the control unit 110 of the contact center support system 100 executes a process of transmitting the emotion recognition result as an emotion recognition result message for the voice frame for which the emotion recognition unit 114 has determined that the emotion recognition result has been confirmed in step S603 (step S603: YES). Thereby, the emotion recognition result for the voice frame is transmitted as an emotion recognition result message. When the process in step S604 is ended, the control unit 110 of the contact center support system 100 proceeds to step S605.

When the process in step S604 is ended, the control unit 110 of the contact center support system 100 returns to step S602 again in step S605. Also, when it is determined in step S603 that the emotion recognition result for the voice frame has not been confirmed (step S603: NO), the control unit 110 of the contact center support system 100 returns to step S602 again.

### (Example of Operations of Customer Voice Conversion Unit 112)

FIG. 7 is a flowchart showing an example of operations of the customer voice conversion unit 112.

In step S701, the control unit 110 of the contact center support system 100 executes a process of acquiring voice frames for a certain period of time by the customer voice conversion unit 112. Thereby, the voice frames for a certain period of time are acquired. When the process in step S701 is ended, the control unit 110 of the contact center support system 100 proceeds to step S702.

In step S702, the control unit 110 of the contact center support system 100 executes a voice conversion process for the voice frames acquired in step S701 by the customer voice conversion unit 112. The voice conversion process refers to various conversion processes, such as flattening of a voice volume and a voice pitch, which are performed on an input voice of the corresponding customer in order to reduce a burden on the operator, and is executed by various technologies of the related art. Thereby, the voice conversion process is performed on the voice frames. As a result, even when an input voice related to the voice frame contains, for example, emotion of anger of the customer, the input voice is modulated so that it sounds to the operator in a relaxed manner, and thus the emotion of the anger is not transmitted as it is to the operator, thereby reducing a burden on the operator. The content of the voice conversion process executed in step S702 is different from the content of the voice conversion process for the operator, which will be described later with reference to FIG. 8. When the process in step S702 is ended, the control unit 110 of the contact center support system 100 proceeds to step S703.

In step S703, the control unit 110 of the contact center support system 100 executes a process of transmitting the voice frame after voice conversion as a voice conversion result message for the voice frame having been subjected to the voice conversion process in step S802 (hereinafter also referred to as the “voice frame after voice conversion”) by the customer voice conversion unit 112. Thereby, the voice frame after voice conversion is transmitted as a voice conversion result message. When the process in step S703 is ended, the control unit 110 of the contact center support system 100 proceeds to step S704.

When the process in step S703 is ended, the control unit 110 of the contact center support system 100 returns to step S702 again in step S704.

### (Example of Operations of Operator Voice Conversion Unit 113)

FIG. 8 is a flowchart showing an example of operations of the operator voice conversion unit 113.

In step S801, the control unit 110 of the contact center support system 100 executes a process of acquiring voice frames for a certain period of time by the operator voice conversion unit 113. Thereby, the voice frames for a certain period of time are acquired. When the process in step S801 is ended, the control unit 110 of the contact center support system 100 proceeds to step S802.

In step S802, the control unit 110 of the contact center support system 100 executes a voice conversion process for the voice frames acquired in step S801 by the operator voice conversion unit 113. The voice conversion process refers to various conversion processes, such as voice quality conversion, which are performed on an input voice of the operator in order to make the voice closer to characteristics of a voice synthesis sound, and is executed by various techniques of the related art. Thereby, the voice conversion process is performed on the frame. As a result, characteristics of an input voice related to the voice frame can be made closer to characteristics of the voice synthesis sound. The content of the voice conversion process executed in step S802 is different from the content of the voice conversion process for the customer described above with reference to FIG. 7. When the process in step S802 is ended, the control unit 110 of the contact center support system 100 proceeds to step S803.

In step S803, the control unit 110 of the contact center support system 100 executes a process of transmitting the voice frame after voice conversion as a voice conversion result message for the voice frame having been subjected to the voice conversion process in step S802, that is, the voice frame after voice conversion, by the operator voice conversion unit 113. Thereby, the voice frame after voice conversion is transmitted as a voice conversion result message. This process executed in step S803 can be omitted as appropriate. When the process in step S803 is ended, the control unit 110 of the contact center support system 100 proceeds to step S804.

When the process in step S803 is ended, the control unit 110 of the contact center support system 100 returns to step S802 again in step S804.

### (Example of Operations of Voice Synthesis Unit 118)

FIG. 9 is a flowchart showing an example of operations of the voice synthesis unit 118.

In step S901, the control unit 110 of the contact center support system 100 executes a process of acquiring text representing the content of utterance of the customer and/or the operator which has been converted into text through the voice recognition process by the voice synthesis unit 118. Thereby, the text is acquired. When the process in step S901 is ended, the control unit 110 of the contact center support system 100 proceeds to step S902.

In step S902, the control unit 110 of the contact center support system 100 executes a voice synthesis process of the text acquired in step S901 by the voice synthesis unit 118. This voice synthesis process is a process of converting the text into voice frames again, and is executed by various techniques of the related art. Thereby, a voice synthesis process is performed on the text. As a result, the text is converted into voice frames again. The voice frames generated through the voice synthesis process are referred to as synthesized voice frames. When the process in step S902 is ended, the control unit 110 of the contact center support system 100 proceeds to step S903.

In step S903, the control unit 110 of the contact center support system 100 executes a process of transmitting the synthesized voice frame generated in step S902 as a message by the voice synthesis unit 118. Thereby, the synthesized voice frame is transmitted as a message. When the process in step S903 is ended, the control unit 110 of the contact center support system 100 proceeds to step S904.

When the process in step S903 is ended, the control unit 110 of the contact center support system 100 returns to step S902 again in step S904.

### (Example of Operations of Filtering Unit 116)

FIG. 10 is a flowchart showing an example of operations of the filtering unit 116.

In step S1001, the control unit 110 of the contact center support system 100 executes a process of acquiring a voice recognition result by the filtering unit 116. Thereby, the voice recognition result is acquired. When the process in step S1001 is ended, the control unit 110 of the contact center support system 100 proceeds to step S1002.

As shown in step S1002, the control unit 110 of the contact center support system 100 repeatedly executes the processes of steps S1002 to S1006 for all words included in the voice recognition result acquired in step S1001 by the filtering unit 116. Each word is extracted from the voice recognition result by morphological analysis or the like. Thereby, the processes of steps S1002 to S1006 are repeatedly executed until the processes for all words included in the voice recognition result are ended.

As shown in step S1003, the control unit 110 of the contact center support system 100 repeatedly executes the processes of steps S1003 to S1006 for all records in the filter dictionary/rule storage database 131 by the filtering unit 116. Thereby, the processes of steps S1003 to S1006 are repeatedly executed for all records in the filter dictionary/rule storage database 131.

In step S1004, the control unit 110 of the contact center support system 100 executes a process of determining whether a word included in the voice recognition result acquired in step S1001 matches the rule of the record by the filtering unit 116. When it is determined in step S1004 that the word matches the rule of the record (step S1004: YES), the process proceeds to step S1005 in order to add a substitute word of the record to the voice recognition result after the process shown in FIG. 10 is performed by the filtering unit 116 (hereinafter also referred to as a “voice recognition result after filtering”). On the other hand, when it is determined in step S1004 that the word does not match the rule of the record (step S1004: NO), the process proceeds to step S1006 in order to add the word to the voice recognition result after filtering.

As described above, the control unit 110 of the contact center support system 100 repeatedly executes the processes of steps S1003 to S1006 for all records in the filter dictionary/rule storage database 131 shown in FIG. 2 by the filtering unit 116. Thereby, the processes of steps S1003 to S1006 are repeatedly executed for all records in the filter dictionary/rule storage database 131. When the processes of steps S1003 to S1006 for all records in the filter dictionary/rule storage database 131 are ended, the control unit 110 of the contact center support system 100 proceeds to the next step.

As described above, the control unit 110 of the contact center support system 100 repeatedly executes the processes of steps S1002 to S1006 for all words included in the voice recognition result acquired in step S1001 by the filtering unit 116. Thereby, the processes of steps S1002 to S1006 are repeatedly executed for all words included in the voice recognition result. When the processes of steps S1002 to S1006 for all words included in the voice recognition result are ended, the control unit 110 of the contact center support system 100 proceeds to step S1008.

In step S1007, the control unit 110 of the contact center support system 100 executes a process of transmitting the voice recognition result after filtering to which the substitute word of the record has been added in step S1005 or transmitting the voice recognition result after filtering to which the word has been added in step S1006, by the filtering unit 116. Thereby, the voice recognition result after filtering is transmitted. When the process in step S1007 is ended, the control unit 110 of the contact center support system 100 proceeds to step S1008.

When the process in step S1007 is ended, the control unit 110 of the contact center support system 100 returns to step S1001 again in step S1008.

### (Example of Operations of Voice Filtering Unit)

FIG. 11 is a flowchart showing an example of operations of the voice filtering unit.

In step S1101, the control unit 110 of the contact center support system 100 executes a process of acquiring the voice recognition result after filtering, which is generated by the filtering unit 116, by the voice filtering unit. Thereby, the voice recognition result after filtering is acquired. When the process in step S1101 is ended, the control unit 110 of the contact center support system 100 proceeds to step S1102.

In step S1102, the control unit 110 of the contact center support system 100 executes a process of acquiring a voice frame after voice conversion, which is generated by the customer voice conversion unit 112 and/or the operator voice conversion unit 113, by the voice filtering unit. Thereby, the voice frame after voice conversion is acquired. When the process in step S1102 is ended, the control unit 110 of the contact center support system 100 proceeds to step S1103.

As shown in step S1103, the control unit 110 of the contact center support system 100 repeatedly executes the processes of steps S1103 to S1104 for all substitute words included in the voice recognition result after filtering which is acquired in step S1101, by the voice filtering unit. Thereby, the processes of steps S1103 to S1104 are repeatedly executed until the processes for all of the substitute words included in the voice recognition result after filtering are ended.

In step S1104, the control unit 110 of the contact center support system 100 executes a process of acquiring a start position and an end position corresponding to the substitute word for the voice frame after voice conversion, which is acquired in step S1102, by the voice filtering unit. Thereby, the start position and the end position of the voice frame after voice conversion corresponding to the substitute word are acquired.

As described above, the control unit 110 of the contact center support system 100 repeatedly executes the processes of steps S1103 to S1104 for all of the substitute words included in the voice recognition result after filtering, which is acquired in step S1101, by the voice filtering unit. Thereby, the processes of steps S1103 to S1104 are repeatedly executed until the processes for all of the substitute words included in the voice recognition result after filtering are ended. When the processes of steps S1103 to S1104 for all of the substitute words included in the voice recognition result after filtering are ended, the control unit 110 of the contact center support system 100 proceeds to step S1105.

When the process in step S1104 is ended, the control unit 110 of the contact center support system 100 returns to step S1102 again in step S1105.

### (Example of Operations of Response Candidate Generation Unit 117)

FIG. 12 is a flowchart showing an example of operations of the response candidate generation unit 117.

In step S1201, the control unit 110 of the contact center support system 100 executes a process of acquiring a voice recognition result by the response candidate generation unit 117. Thereby, the voice recognition result is acquired. When the process in step S1201 is ended, the control unit 110 of the contact center support system 100 proceeds to step S1202.

As shown in step S1202, the control unit 110 of the contact center support system 100 repeatedly executes the processes of steps S1202 to S1203 for all records in the response candidate generation data storage database 132 shown in FIG. 3 by the response candidate generation unit 117. Thereby, the processes of steps S1202 to S1203 are repeatedly executed until the processes are ended for all of the records in the response candidate generation data storage database 132.

In step S1203, the control unit 110 of the contact center support system 100 executes a process of calculating a similarity score between a question sentence of the record and the voice recognition result acquired in step S1201 by the response candidate generation unit 117. Thereby, the similarity score between the question sentence of the record and the voice recognition result is calculated. When the process in step S1203 is ended, the control unit 110 of the contact center support system 100 proceeds to step S1204.

As described above, the control unit 110 of the contact center support system 100 repeatedly executes the processes of steps S1202 to S1203 for all of the records in the response candidate generation data storage database 132 by the response candidate generation unit 117. Thereby, the processes of steps S1202 to S1203 are repeatedly executed until the processes are ended for all of the records in the response candidate generation data storage database 132. When the processes of steps S1202 to S1203 for all of the records in the response candidate generation data storage database 132 are ended, the control unit 110 of the contact center support system 100 proceeds to step S1204.

In step S1204, the control unit 110 of the contact center support system 100 executes a process of extracting the three highest similarity scores and transmitting response candidates thereof by the response candidate generation unit 117. Thereby, the three highest similarity scores are extracted, and the response candidates are transmitted. When the process in step S1204 is ended, the control unit 110 of the contact center support system 100 proceeds to step S1205.

When the process in step S1204 is ended, the control unit 110 of the contact center support system 100 returns to step S1202 again in step S1205.

### (Example of Operations of Operator Screen Control Unit 123)

FIG. 13 is a flowchart showing an example of operations of the operator screen control unit 123.

In step S1301, the control unit 110 of the contact center support system 100 executes a process of acquiring a voice recognition result after filtering, an emotion recognition result, response candidates, and response candidate selection to be displayed on the display 13 of the operator terminal 10 by the operator screen control unit 123. These processes are performed in parallel. Thereby, the voice recognition result after filtering, the emotion recognition result, the response candidates, and the response candidate selection are acquired. When the process in step S1301 is ended, the control unit 110 of the contact center support system 100 proceeds to steps S1302 to S1305 in accordance with the content of the process to be executed.

In step S1302, the control unit 110 of the contact center support system 100 executes a process of displaying the voice recognition result after filtering on the display 13 of the operator terminal 10 by the operator screen control unit 123. Thereby, the voice recognition result after filtering is displayed on the display 13 of the operator terminal 10. At this time, a voice is output to the speaker 12 of the operator terminal 10. When the process in step S1302 is ended, the control unit 110 of the contact center support system 100 proceeds to step S1306.

In step S1303, the control unit 110 of the contact center support system 100 executes a process of displaying the emotion recognition result on the display 13 of the operator terminal 10 by the operator screen control unit 123. Thereby, the emotion recognition result is displayed on the display 13 of the operator terminal 10. When the process in step S1303 is ended, the control unit 110 of the contact center support system 100 proceeds to step S1306.

In step S1304, the control unit 110 of the contact center support system 100 executes a process of displaying the response candidates on the display 13 of the operator terminal 10 by the operator screen control unit 123. Thereby, the response candidates are displayed on the display 13 of the operator terminal 10. When the process in step S1303 is ended, the control unit 110 of the contact center support system 100 proceeds to step S1306.

In step S1305, the control unit 110 of the contact center support system 100 executes a process of transmitting a message indicating the result of the operator's selection operation for the response candidates displayed on the display 13 of the operator terminal 10 (hereinafter also referred to as a “response candidate selection result”) to the control unit 110 by the operator screen control unit 123. Thereby, the response candidate selection result is transmitted to the control unit 110 of the contact center support system 100. When the process in step S1305 is ended, the control unit 110 of the contact center support system 100 proceeds to step S1306.

When the processes in steps S1302 to S1305 are ended, the control unit 110 of the contact center support system 100 returns to step S1301 again in step S1306.

### (Example of Operations of Customer Voice Transmission Unit 122)

FIG. 14 is a flowchart showing an example of operations of the customer voice transmission unit 122.

In step S1401, the control unit 110 of the contact center support system 100 executes a process of acquiring a voice frame after filtering by the customer voice transmission unit 122. Thereby, the voice frame after filtering is acquired. When the process in step S1401 is ended, the control unit 110 of the contact center support system 100 proceeds to step S1402.

Even when the voice frame after filtering is not acquired in step S1401, the control unit 110 of the contact center support system 100 proceeds to step S1402 when a predetermined period of time has elapsed since the last output of the speaker 22 of the customer terminal 20, such as when the operator has difficulty in searching.

In step S1402, the control unit 110 of the contact center support system 100 executes a process of determining whether a predetermined period of time has elapsed since the last output of the speaker 22 of the customer terminal 20 by the customer voice transmission unit 122. When it is determined in step S1402 that the predetermined period of time has elapsed since the last output of the speaker 22 of the customer terminal 20 (step S1402: YES), the process proceeds to step S1403 in order to divide standby voice data into frames and add them to an input buffer of the customer voice transmission unit 122. On the other hand, when it is determined in step S1402 that the predetermined period of time has not yet elapsed since the last output of the speaker 22 of the customer terminal 20 (step S1402: NO), the process proceeds to step S1404 in order to output the voice to the speaker 22 of the customer terminal 20.

In step S1403, the control unit 110 of the contact center support system 100 executes a process of dividing the standby voice data into frames by the customer voice transmission unit 122 and adding them to the input buffer of the customer voice transmission unit 122. Thereby, the standby voice data is divided into frames, and the frames are added to the input buffer of the customer voice transmission unit 122. The customer voice transmission unit 122 may generate standby voice text instead of the standby voice data and use voice data synthesized by the voice synthesis unit 118. The standby voice text generated in this case may be a fixed phrase such as “Please wait a moment”, or may receive the latest customer voice recognition result and use it as a confirmation response, for example, “Your question is (the latest customer voice recognition result), right?”. When the process in step S1403 is ended, the control unit 110 of the contact center support system 100 proceeds to step S1405. In step S1404, the control unit 110 of the contact center support system 100 executes a process of outputting the voice to the speaker 22 of the customer terminal 20 by the customer voice transmission unit 122. At this time, the customer voice transmission unit 122 may transmit the voice in accordance with the standby voice data storage database 133. When the process in step S1404 is ended, the control unit 110 of the contact center support system 100 proceeds to step S1405.

When the process in step S1403 or the process in step S1404 is ended, the control unit 110 of the contact center support system 100 returns to step S1202 again in step S1405.

### (Example of Operations of Control Unit 110)

FIG. 15 is a flowchart showing an example of a flow of the overall processing executed by the control unit 110.

As described above, the control unit 110 of the contact center support system 100 executes each process shown in FIG. 15 as a multi-process process. That is, the control unit 110 operates the functional blocks, that is, the voice recognition unit 111, the customer voice conversion unit 112, the operator voice conversion unit 113, the emotion recognition unit 114, the filter restoration unit 115, the filtering unit 116, the response candidate generation unit 117, the voice synthesis unit 118, the customer voice detection unit 119, the operator voice transmission unit 120, the operator voice detection unit 121, the customer voice transmission unit 122, and the operator screen control unit 123 in parallel, independently of each other, without synchronizing them with each other. In addition, the contact center support system 100 communicates with the operator terminal 10 and/or the customer terminal 20 by transmitting and receiving messages to and from each other.

In step S151, the control unit 110 of the contact center support system 100 starts various processes to be executed mainly in response to the reception of a message. Thereby, various processes are started to be executed by the control unit 110. When the process in step S151 is ended, the control unit 110 of the contact center support system 100 proceeds to step S152.

In step S152, the control unit 110 of the contact center support system 100 executes a process of acquiring a message from a message queue. Thereby, the message is acquired from the message queue. When the process in step S152 is ended, the control unit 110 of the contact center support system 100 proceeds to step S153. In step S153, the control unit 110 of the contact center support system 100 executes a process of determining the type of the message acquired in step S152. Depending on the result of the determination process executed in step S153, the control unit 110 proceeds to any one of steps S1501 to S1591 shown in FIG. 15.

### (When Message is Related to Customer Voice Frame)

In step S1501, when the message is related to a customer voice frame (hereinafter also simply referred to as a “voice frame”), the control unit 110 of the contact center support system 100 executes a process of transmitting the voice frame to the voice recognition unit 111. Thereby, the voice frame is transmitted to the voice recognition unit 111. When the process in step S1501 is ended, the control unit 110 of the contact center support system 100 proceeds to step S1502.

In step S1502, the control unit 110 of the contact center support system 100 executes a process of transmitting the voice frame to the emotion recognition unit 114. Thereby, the voice frame is transmitted to the emotion recognition unit 114. When the process in step S1502 is ended, the control unit 110 of the contact center support system 100 proceeds to step S1503.

In step S1503, the control unit 110 of the contact center support system 100 executes a process of transmitting the voice frame to the customer voice conversion unit 112. Thereby, the voice frame is transmitted to the customer voice conversion unit 112. When the process in step S1503 is ended, the control unit 110 of the contact center support system 100 proceeds to step S154.

### (When Message is Related to Operator Voice Frame)

In step S1511, when the message is related to an operator voice frame (hereinafter also simply referred to as a “voice frame”), the control unit 110 of the contact center support system 100 executes a process of transmitting the voice frame to the voice recognition unit 111. Thereby, the voice frame is transmitted to the voice recognition unit 111. When the process in step S1511 is ended, the control unit 110 of the contact center support system 100 proceeds to step S154.

### (When Message is Related to Voice Recognition Result)

In step S1521, when the message is related to a voice recognition result, the control unit 110 of the contact center support system 100 executes a process of transmitting the voice recognition result to the response candidate generation unit 117. Thereby, the voice recognition result is transmitted to the response candidate generation unit 117. When the process in step S1521 is ended, the control unit 110 of the contact center support system 100 proceeds to step S1522.

In step S1522, the control unit 110 of the contact center support system 100 executes a process of transmitting the voice recognition result to the filtering unit 116. Thereby, the voice recognition result is transmitted to the filtering unit 116. When the process in step S1522 is ended, the control unit 110 of the contact center support system 100 proceeds to step S154.

### (When Message is Related to Response Candidate)

In step S1531, when the message is related to a response candidate, the control unit 110 of the contact center support system 100 executes a process of transmitting the response candidate to the operator screen control unit 123. Thereby, the response candidate is transmitted to the operator screen control unit 123. When the process in step S1531 is ended, the control unit 110 of the contact center support system 100 proceeds to step S154.

### (When Message is Related to Response Candidate Selection Result)

In step S1541, when the message is related to a response candidate selection result, the control unit 110 of the contact center support system 100 executes a process of transmitting the response candidate selection result to the filter restoration unit 115. Thereby, the response candidate selection result is transmitted to the filter restoration unit 115. When the process in step S1541 is ended, the control unit 110 of the contact center support system 100 proceeds to step S154.

(When Message is Related to Response Candidate Selection Result after Filter Restoration)

In step S1551, when the message is related to a response candidate selection result after filter restoration, the control unit 110 of the contact center support system 100 executes a process of transmitting the response candidate selection result after filter restoration to the voice synthesis unit 118. Thereby, the response candidate selection result after filter restoration is transmitted to the voice synthesis unit 118. When the process in step S1551 is ended, the control unit 110 of the contact center support system 100 proceeds to step S154.

(When Message is Related to Voice Recognition Result after Filtering)

In step S1561, when the message is related to a voice recognition result after filtering, the control unit 110 of the contact center support system 100 executes a process of transmitting the voice recognition result after filtering to the operator screen control unit 123. Thereby, the voice recognition result after filtering is transmitted to the operator screen control unit 123. When the process in step S1561 is ended, the control unit 110 of the contact center support system 100 proceeds to step S1562.

In step S1562, the control unit 110 of the contact center support system 100 executes a process of transmitting the voice recognition result after filtering to the voice filtering unit. Thereby, the voice recognition result after filtering is transmitted to the voice filtering unit. When the process in step S1562 is ended, the control unit 110 of the contact center support system 100 proceeds to step S154.

### (When Message is Related to Emotion Recognition Result)

In step S1571, when the message is related to an emotion recognition result, the control unit 110 of the contact center support system 100 executes a process of transmitting the emotion recognition result to the operator screen control unit 123. Thereby, the emotion recognition result is transmitted to the operator screen control unit 123. When the process in step S1571 is ended, the control unit 110 of the contact center support system 100 proceeds to step S154.

### (When Message is Related to Voice Conversion Result)

In step S1581, when the message is related to a voice conversion result, the control unit 110 of the contact center support system 100 executes a process of transmitting a voice frame after voice conversion representing the voice conversion result to the voice filtering unit. Thereby, the voice frame after voice conversion is transmitted to the voice filtering unit. When the process in step S1581 is ended, the control unit 110 of the contact center support system 100 proceeds to step S154.

(When Message is Related to Voice Frame after Voice Filtering)

In step S1591, when the message is related to a voice frame after voice filtering, the control unit 110 of the contact center support system 100 executes a process of transmitting the voice frame after voice filtering to the customer voice transmission unit 122. Thereby, the voice frame after voice filtering is transmitted to the customer voice transmission unit 122. When the process in step S1591 is ended, the control unit 110 of the contact center support system 100 proceeds to step S154.

When the process in each of steps S1501 to S1591 is ended, the control unit 110 of the contact center support system 100 returns to step S151 again in step S154.

The above-described embodiment of the invention is summarized as follows.

(1) The contact center support system 100 is a system that supports a contact center, and includes the control unit 110 that executes a plurality of processes for communication performed between an operator of the contact center and a customer, the communication includes a call between the operator and the customer, the plurality of processes include at least a voice recognition process of recognizing at least the content of the customer's utterance from a voice of the call, an emotion recognition process of recognizing at least the customer's emotion from the voice of the call, and a filtering process of filtering the content of the utterance of the customer and/or the operator in the call, and the control unit 110 simultaneously executes the processes included in the plurality of processes in parallel. Thereby, the contact center support system 100 can execute operations of the respective functional blocks included in the control unit 110, that is, the plurality of processes as parallel processes, as shown in FIG. 1 and FIG. 15. In addition, when the filtering process shown in FIG. 10 is executed by the filtering unit 116, the control unit 110 of the contact center support system 100 executes a loop process after subdividing each record in the filter dictionary/rule storage database 131 and each word included in a voice recognition result. As a result, the contact center support system 100 can minimize delays in communication such as calls between operators and customers at the contact center and perform filtering on the communication in real time.

(2) A response to the customer in the call is made by a voicebot that utters the content of text input by the operator, or by the operator's utterance, and the control unit 110 reproduces a standby voice when the operator's input of text or a voice is not detected for a predetermined period of time during the call. In this manner, the contact center support system 100 can significantly shorten a standby time on the customer side in the call. As a result, it is possible to eliminate or alleviate the customer's dissatisfaction in the call.

(3) The response to the customer in the call is made by the utterance of the voicebot, and a voice uttered by the voicebot is subjected to a voice synthesis process so as to have the same tone as the standby voice and is reproduced subsequently to the reproduction of the standby voice.

(4) The response to the customer in the call is made by the operator's utterance, and the voice uttered by the operator is subjected to a voice synthesis process and/or a voice quality conversion process so as to have the same tone as the standby voice and is reproduced subsequently to the reproduction of the standby voice.

(5) The voice recognition process includes a process of converting the voice uttered by the customer in the call into text, the filtering process further includes a masking process of, when a predetermined word is included in the text description, converting the word into another word to present the text to the operator in a form in which a content represented by the word is concealed, and when the response to the customer is made by the utterance of the voicebot, the control unit 110 restores the word to the word before conversion by the masking process when the other word is included in the text input by the operator.

(6) The control unit 110 executes the plurality of processes as s synchronous process.

(7) The control unit 110 executes the plurality of processes as an asynchronous process.

(8) The contact center support system 100 is a system that supports a contact center, and includes the control unit 110 that executes a plurality of processes for communication performed between an operator of the contact center and a customer, the communication includes a call between the operator and the customer, the plurality of processes includes at least a voice recognition process of recognizing at least the content of the customer's utterance from a voice of the call, an emotion recognition process of recognizing at least the customer's emotion from the voice of the call, and an emotion synthesis process of analyzing the voice of the call, alleviating or invalidating parameters for determining the customer's emotion in the call, and resynthesizing the voice, the parameters include at least a pitch of the voice that represents the tone of the customer's voice, or a voice volume of the voice that represents a volume of the customer's voice, and the control unit 110 simultaneously executes the processes included in the plurality of processes in parallel.

The invention is not limited to the above embodiment, and can be implemented using any components without departing from the scope of the invention.

The above embodiment, examples, and modifications are merely examples, and the invention is not limited to these contents as long as the features of the invention are not impaired. In addition, although various embodiments, examples, and modifications have been described above, the invention is not limited to these contents. Other aspects that are conceivable within the scope of the technical ideas of the invention are also included in the scope of the invention.

In the above-described drawings, control lines and information lines that are considered to be necessary for description are shown, and all mounted control lines and information lines are not necessarily shown. For example, it may be considered that almost all components are actually connected to each other.

The above-described layout of the functional units of the contact center support system 100 is merely an example. The layout of the functional units can be changed to an optimal layout from the viewpoint of the performance, processing efficiency, communication efficiency, and the like of the hardware and software included in the contact center support system 100.

What is claimed is:

1. A contact center support system that supports a contact center, the contact center support system comprising:
a control unit that executes a plurality of processes for communication performed between an operator of the contact center and a customer, wherein
the communication includes a call between the operator and the customer,
the plurality of processes include at least
a voice recognition process of recognizing at least a content of the customer's utterance from a voice of the call,
an emotion recognition process of recognizing at least the customer's emotion from the voice of the call, and
a filtering process of filtering the content of the utterance of the customer and/or the operator in the call, and
the control unit simultaneously executes the processes included in the plurality of processes in parallel.

2. The contact center support system according to claim 1, wherein
a response to the customer in the call is made by a voicebot that utters the content of text input by the operator or by the operator's utterance, and
the control unit reproduces a standby voice when the operator's input of text or a voice is not detected for a predetermined period of time during the call.

3. The contact center support system according to claim 2, wherein
the response to the customer in the call is made by the utterance of the voicebot, and
a voice uttered by the voicebot is subjected to a voice synthesis process so as to have the same tone as the standby voice and is reproduced subsequently to the reproduction of the standby voice.

4. The contact center support system according to claim 2, wherein
the response to the customer during the call is made by the operator's utterance, and
the voice uttered by the operator is subjected to a voice synthesis process and/or a voice quality conversion process so as to have the same tone as the standby voice and is reproduced subsequently to the reproduction of the standby voice.

5. The contact center support system according to claim 3, wherein
the voice recognition process includes a process of converting the voice uttered by the customer in the call into text,
the filtering process includes a masking process of, when a predetermined word is included in the text description, converting the word into another word to present the text to the operator in a form in which a content represented by the word is concealed, and
when the response to the customer is made by the utterance of the voicebot, the control unit restores the word to the word before conversion by the masking process when the other word is included in the text input by the operator.

6. The contact center support system according to claim 1, wherein the control unit executes the plurality of processes as a synchronous process.

7. The contact center support system according to claim 1, wherein the control unit executes the plurality of processes as an asynchronous process.

8. A contact center support system that supports a contact center, the contact center support system comprising:
a control unit that executes a plurality of processes for communication performed between an operator of the contact center and a customer, wherein
the communication includes a call between the operator and the customer,
the plurality of processes include at least
a voice recognition process of recognizing at least a content of the customer's utterance from a voice of the call,
an emotion recognition process of recognizing at least the customer's emotion from the voice of the call, and
an emotion synthesis process of analyzing the voice of the call, alleviating or invalidating parameters for determining the customer's emotion in the voice, and resynthesizing the voice,
the parameters include at least a pitch of the voice that represents the tone of the customer's voice or a voice volume of the voice that represents a volume of the customer's voice, and
the control unit simultaneously executes the processes included in the plurality of processes in parallel.

9. The contact center support system according to claim 8, wherein
a response to the customer in the call is made by a voicebot that utters the content of text input by the operator or by the operator's utterance, and
the control unit reproduces a standby voice when the operator's input of text or a voice is not detected for a predetermined period of time during the call.

10. The contact center support system according to claim 9, wherein
the response to the customer in the call is made by the utterance of the voicebot, and
a voice uttered by the voicebot is subjected to a voice synthesis process so as to have the same tone as the standby voice and is reproduced subsequently to the reproduction of the standby voice.

11. The contact center support system according to claim 9, wherein
the response to the customer during the call is made by the operator's utterance, and
the voice uttered by the operator is subjected to a voice synthesis process and/or a voice quality conversion process so as to have the same tone as the standby voice and is reproduced subsequently to the reproduction of the standby voice.

12. The contact center support system according to claim 10, wherein
the voice recognition process includes a process of converting the voice uttered by the customer in the call into text,
the filtering process includes a masking process of, when a predetermined word is included in the text description, converting the word into another word to present the text to the operator in a form in which a content represented by the word is concealed, and
when the response to the customer is made by the utterance of the voicebot, the control unit restores the word to the word before conversion by the masking process when the other word is included in the text input by the operator.

13. The contact center support system according to claim 8, wherein the control unit executes the plurality of processes as a synchronous process.

14. The contact center support system according to claim 8, wherein the control unit executes the plurality of processes as an asynchronous process.

15. A contact center support method of supporting a contact center, wherein
a computer including at least a processor and a storage apparatus includes a control unit that executes a plurality of processes for communication performed between an operator of the contact center and a customer,
the communication includes a call between the operator and the customer,
the plurality of processes include a voice recognition process of recognizing at least a content of the customer's utterance from a voice of the call, and an emotion recognition process of recognizing at least the customer's emotion from the voice of the call, and include at least any one of a filtering process of filtering the content of the utterance of the customer and/or the operator in the call, and an emotion synthesis process of analyzing the voice of the call, alleviating or invalidating parameters for determining the customer's emotion in the voice, and resynthesizing the voice, and
the control unit simultaneously executes the processes included in the plurality of processes in parallel.
